(19) United States
(12) Patent Application Publication
(10) Pub. No.: US 2008/0125290 A1
(43) Pub. Date: May 29, 2008

(54) Magnetized Exercise Mat

(76) Inventor: Richard Cabados, Encinitas, CA (US)

Correspondence Address: ERIC HANSCOM, 7395 PORTAGE WAY, CARLSBAD, CA, 92011, US

(21) Appl. No.: 12/025,702

(22) Filed: Feb. 4, 2008

Related U.S. Application Data
(63) Continuation of application No. 11/388,949, filed on Mar. 27, 2006.

(51) Int. Cl. B32B 5/22

(52) U.S. Cl. 482/23

(57) ABSTRACT

The present invention involves an exercise mat having magnetic properties. The mat is preferably rectangular in shape and comprised of magnetized polyvinyl chloride foam material. A thin net layer of fibers can be positioned on top of and/or below the foam layer to increase strength and durability. The foam material can contain a magnetic flux in the range of 400 gauss to 1200 gauss, preferably 400 gauss to 800 gauss. Alternatively, the exercise mat can comprise an inner layer of magnetic material surrounded by outer layers of non-magnetized foam material. The exercise mat can also contain two or more handle grips or support openings for use when performing various activities, such as yoga or aerobic exercises.

### CROSS REFERENCE TO RELATED APPLICATIONS

This application is a continuation of U.S. patent application Ser. No. 11/388,949 filed on Mar. 27, 2006, which is hereinafter incorporated by reference.

### STATEMENT REGARDING FEDERALLY SPONSORED RESEARCH OR DEVELOPMENT

This invention was not federally sponsored.

### BACKGROUND OF THE INVENTION

1. Field of the Invention

The invention generally relates to the field of exercise mats. More particularly, the present invention relates to exercise mats, in particular yoga mats, having magnetic properties.

2. Description of the Related Art

Many exercise activities, including aerobic activities, involve positioning oneself on a floor or other flat surface while performing various movements. One such activity, yoga, has been practiced for many centuries. More recently, yoga has become a popular and cost-effective way to help achieve relaxation and relieve stress in the United States. Many yoga practitioners use a yoga mat when practicing yoga. Yoga mats are helpful in that they provide a more sanitary and comfortable practicing surface than a bare floor. However, most yoga mats do nothing more than act as a static surface for exercises to be performed on.

Some inventions have attempted to utilize the principles of magnetism to achieve a variety of health-related benefits. Magnetic therapy has a long history dating back to the time of Cleopatra, when the Queen wore a magnet on her face to preserve her youthful appearance. The use of magnets has also been used by NASA to treat astronauts who complained of weakness after returning from space, as well as professional athletes who seek to treat injuries.

There are many observed actions or effects caused by magnets on biologic processes, including chemical reactions, ion movement, changes in charges and electrical potentials, effects on lipids, starches and proteins, hormones and the large molecules and fundamental cellular processes, among others. However, there is no accepted concept in physics yet of how magnetic fields affect these biologic activities. Many theories have been suggested as to how magnetic therapy works. One theory is that all injuries generate positive magnetic fields and that application of a negative magnetic field relieves pain and speeds healing. Another theory suggests that magnets stimulate red blood cells that have iron. Yet another theory indicates that magnets placed on the body separate positive and negative ions in the blood which physically pushes the walls of blood vessels apart resulting in increased blood flow. Further, magnets also have been theorized to stimulate neurons, blocking signals that cause pains.

Magnetic devices used to treat various health-related conditions have come in various sizes and embodied various shapes. For instance, magnets have been used in items ranging from mattress pads and liners to joint wraps. These inventions however, require that either magnets be placed within the non-magnetic material or magnetic material be attached to the non-magnetic material. These requirements can increase the cost of producing such devices as well as increase the complexity of the manufacturing process.

Therefore, there is a present need for an exercise mat that has magnetic properties that can be safely and comfortably used in performing various exercises, including yoga and aerobic activities.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

### SUMMARY OF THE INVENTION

A primary object of this invention is to provide an exercise mat with magnetic properties that can be used when performing various exercises, including yoga and aerobic activities.

An additional object of the invention is to provide a magnetized yoga mat where the natural, inherent beneficial qualities of magnets—namely to energize the yogi, or yoga practitioner and allow him/her to practice yoga with less strain, quicker recovery from muscle extensions, enhanced flexibility, a calmer, more centered feeling, and more concentration.

It is a further object of this invention to provide a mat having hand support means to aid in the performance of various exercises, including yoga.

It is another object of this invention to provide a mat that is comfortable to use while performing various exercises.

It is a still another object of this invention to provide a unique magnetized mat to the field of exercise mats.

These objects and further objects and features of the invention will be apparent to one skilled in the art from the disclosure of the present invention as set forth herein.

The present invention involves an exercise mat having magnetic properties. The mat is preferably rectangular in shape and comprised of magnetized polyvinyl chloride foam material. A thin net layer of fibers can be positioned on top of and/or below the foam layer to increase strength and durability. The foam material can contain a magnetic flux in the range of 400 gauss to 3950 gauss, preferably 400 gauss to 1200 gauss. Alternatively, the exercise mat can comprise an inner layer of magnetic material surrounded by outer layers of non-magnetized foam material. The exercise mat can also contain two or more hand grips or support openings for use when performing various activities, such as yoga or aerobic exercises.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

The accompanying drawings, which are incorporated in and form a part of this specification, illustrate embodiments of the invention and together with the description, serve to explain the principals of this invention.

FIG. 1 is perspective view of the preferred embodiment of the exercise mat with hand grips attached.

FIG. 2 is cross-sectional view of the preferred embodiment of the exercise mat.

FIG. 3 is cross-sectional view of an alternate embodiment of the exercise mat.

FIG. 4 shows an alternative embodiment of the exercise mat containing support openings to help with stability during exercise.

FIG. 5 shows an alternative embodiment of the exercise mat containing hand grips secured to the base with attachment rings.

### DETAILED DESCRIPTION OF THE INVENTION

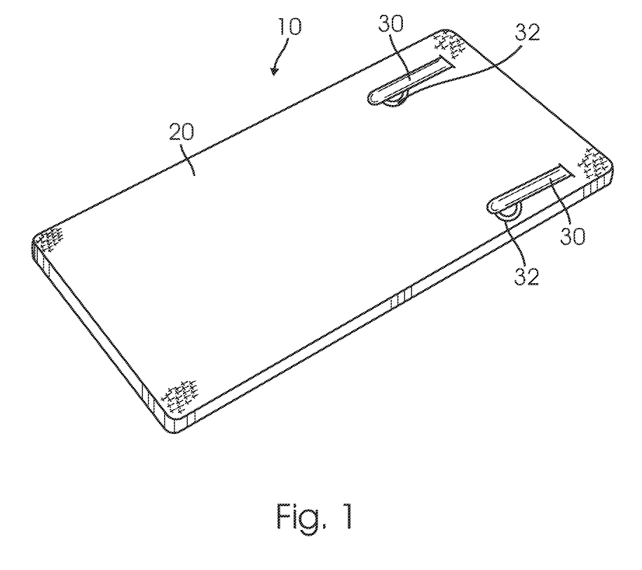

Referring now to the drawings, FIG. 1 shows a perspective view of the preferred embodiment of exercise mat 10. Exercise mat 10 is comprised of a base 20, preferably comprised of, but not limited to, a polyvinyl chloride foam material. Base 20 is preferably rectangular in shape, but can vary in shape depending on the type of the exercise to be performed and the size of the yoga practitioner. Dimensions of base 20 are preferably 68 inches by 24 inches, but can vary in size depending on the type of exercise to be performed. Exercise mat 10 can include hand grips 30 for additional support while performing various exercises. Hand grips 30 are preferably attached within base 20. However, hand grips 30 can also be removably attached to base 20 to enable a user to attach or remove hand grips 30 to perform exercises that either may or may not require hand grips 30. Hand grips 30 each have a handle portion 32, which can be of various shape and design so long as a user is able to comfortably grip handle portion 32. Hand grips 30 and handle portions 32 can be comprised of nylon, cotton, rubber, or any other material that is flexible and comfortable to grip.

Base 20 contains magnetic properties as a result of being magnetized. Base 20 can be magnetized in various ways as would be recognized by one with ordinary skill in the art. Base 20 preferably has a magnetic flux of between 400 gauss to 1200 gauss measured at a surface of the device, or even more preferably between 400 and 800 gauss, but can contain a magnetic flux in the range of 350 gauss to 3950 gauss. Magnetic fluxes are best measured at the surface of the object, as these are the actual magnetic fluxes that are perceived by the user. Internal measurements, while informative, may not accurately reflect that magnetic flux that inundates the user. Therefore surface measurements are of more importance and help clearly and distinctly claim Applicant's invention. At such levels, base 20 can remain magnetized for approximately 3-5 years. However, base 20 may remain magnetized for more or less time depending on factors such as environmental conditions, manner of use, and amount of use.

A magnetic flux in the range of 400 gauss to 1200 gauss, or more preferably 400 gauss to 800 gauss has a higher beneficial effect on a user over the prior art. More specifically, a magnetic flux in the range of 400 gauss to 500 gauss measured at the surface of the mat can have an impact on tissue one to two inches deep. While a wide range of magnetic fluxes may provide some benefit to a user, it is believed that magnetic fluxes in the range of 400 gauss to 1200 gauss, and more specifically 400 gauss to 800 gauss, have beneficial treatments on the skin that cannot be obtained with higher or lower magnetic fluxes. Lower magnetic fluxes are unable to penetrate as deeply into the tissue of the user. Higher magnetic fluxes, such as those above 1200 gauss, can be more expensive to produce and provide little further benefit to the user over devices with lower magnetic fluxes. Therefore, it is beneficial to have a yoga mat with a magnetic flux of 1200 gauss or lower that provides significant benefit to the user while at a lower cost. The upper and lower bounds of the magnetic flux are critical and substantial limitations on the current invention, and therefore it is not an obvious improvement over the prior art.

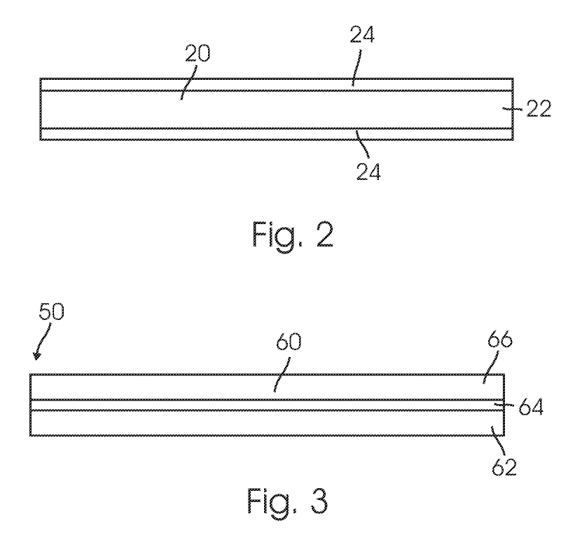

FIG. 2 shows a cross-sectional view of the preferred embodiment of base 20. As depicted, base 20 is substantially comprised of one segment of magnetized polyvinyl chloride foam material 22. However, base 20 can be comprised of other material that is flexible, durable, and can retain magnetic properties for at least about 3 years, as would be recognized by one with ordinary skill in the art. Base 20 can also contain an outer layer 24, on one or both sides, comprised of a thin polymer fiber coating to help increase strength and durability.

FIG. 3 shows a cross-sectional view of a base 60 of an alternative embodiment of exercise mat 50. Base 60 is comprised of a bottom portion 62, middle portion 64, and top portion 66. Bottom portion 62 is comprised of a flexible and substantially impermeable material, such as rubber. Middle portion 64 is preferably comprised of a magnetized flexible polyvinyl chloride foam material, but can be comprised of other durable and flexible material that is capable of retaining magnetic properties for at least about 3 years. Top portion 66 is comprised of a flexible and semi-permeable (partially absorbent) material. In this embodiment, top portion 66 can absorb moisture from a user to provide for a drier and more comfortable exercise surface. Exercise mat 50 can further comprise a thin layer of polymer fiber laminate coating matrix (not shown) positioned on or within the distal surface of top portion 66 for the purpose of increasing strength and durability, while not hindering the partially absorbent qualities of top portion 66. As a practical matter, it is desirable to have at nylon netting or other nylon material on at least one side of the yoga mat for structural support.

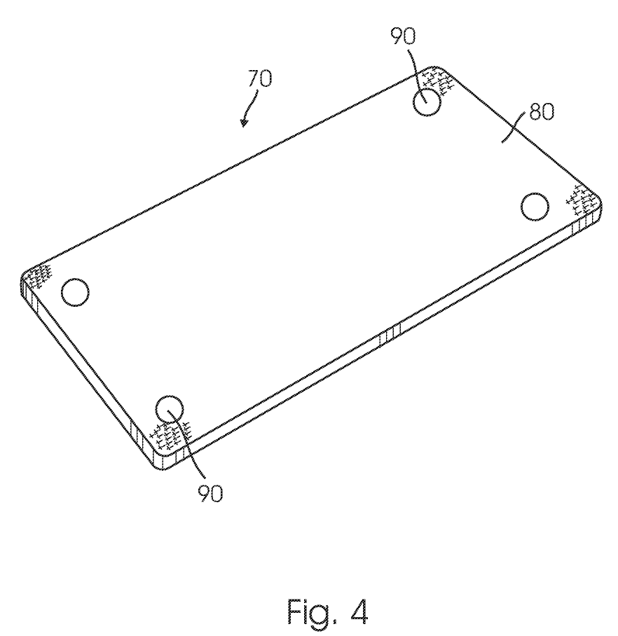

FIG. 4 shows a perspective view of an alternate embodiment exercise mat 70. Exercise mat 70 contains a base 80. Base 80 includes support openings 90. Support openings 90 provide support for arms or legs during performance of certain exercises, particularly yoga poses and stretches. Support openings 90 are preferably round or oval in shape. However, support openings 90 can also be slits that expand or contract depending on whether or not an appendage is positioned therethrough. Base 80 preferably includes four support openings 90. However, base 80 can include two or more support openings 90. Support openings 90 are preferably positioned at each corner of base 80. However, support openings 90 can also be placed along the peripheral portion of base 80 to provide support means at various locations throughout base 80. Support openings 90 can be various sizes to accommodate either arms or legs. Further, one end of base 80 can contain smaller support openings 90 to accommodate arms, while the other end of base 80 can contain larger support openings 90 to accommodate legs.

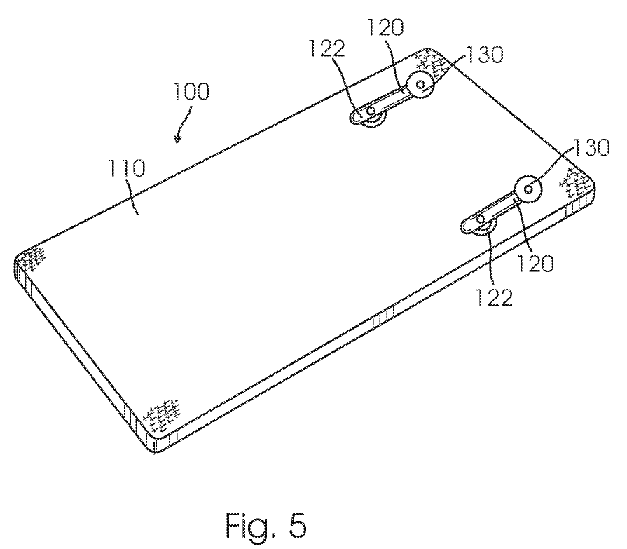

FIG. 5 shows another alternative embodiment of the exercise mat 100. Exercise mat 100 contains a base 110 having at least two hand grips 120. Hand grips 120 each have a handle portion 122 and are attached to exercise mat 100 by attachment rings 130. Handle portion 122 can be of various shapes and designs so long as a user is able to comfortably grip handle portion 122. Hand grips 120 and handle portions 122 can be comprised of nylon, cotton, rubber, or any other material that is flexible and comfortable to grip. Attachment rings 130 can be incorporated into hand grips 120 or can be formed as a part of base 110. If attachment rings 130 are formed as a part of base 110, hand grips 120 would be removably attachable to attachment rings 130.

With respect to the above description it is to be realized that the optimum dimensional relationships for the parts of the invention, including variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents fall within the scope of the present invention.

The above description, together with the objects of the invention and the various features of novelty which characterize the invention, are pointed out with particularity in the claims annexed to and forming a part of this disclosure. For a better understanding of the invention, its operating advantages and the specific advantages attained by its uses, reference should be made to the accompanying drawings and descriptive matter in which there are illustrated preferred embodiments of the invention.

Further, the purpose of the foregoing abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting, as to the scope of the invention in any way.

I claim:

1. An exercise mat comprising:
a) a magnetized layer of material; and
b) a non-magnetized layer of material positioned on at least one side of the magnetized layer of material for the purpose of increasing strength and durability
wherein the magnetized layer has a magnetic flux in the range of 400 gauss to 1200 gauss measured at an external surface of the mat,
whereby the exercise mat provides magnetic stimulation while a user engages the exercise mat while performing various exercise activities, including yoga.

2. The exercise mat of claim 1, wherein the magnetized layer of material comprises polyvinyl chloride foam.

3. The exercise mat of claim 1, wherein the non-magnetized layer of material is positioned on each side of the magnetized layer of material.

4. The exercise mat of claim 1, wherein the non-magnetized layer of material is a polymer fiber laminate.

5. The exercise mat of claim 1, further comprising means for supporting a user coupled to the magnetized layer of material.

6. The exercise mat of claim 5, wherein the means for supporting a user is at least one hand grip.

7. The exercise mat of claim 1, further comprising at least one opening in the magnetized layer and the non-magnetized layer for the purpose of providing support to a user during various exercise activities.

8. The exercise mat of claim 1, wherein the magnetized layer has a magnetic flux in the range of 400 gauss to 500 gauss measured at an external surface of the mat.

9. An exercise mat comprising:
a) a magnetized layer of material;
b) a non-magnetized layer of material positioned on at least one side of the magnetized layer of material; and
c) means for enabling a user to grip the exercise mat coupled to the magnetized layer of material thereby supporting a user while he or she uses the exercise mat,
wherein the magnetized layer has a magnetic flux in the range of 400 gauss to 800 gauss measured at an external surface of the mat,
whereby the exercise mat provides magnetic stimulation while a user engages the exercise mat while performing various exercise activities, including yoga.

10. The exercise mat of claim 9, wherein the magnetized layer of material comprises polyvinyl chloride foam.

11. The exercise mat of claim 9, wherein the non-magnetized layer of material is positioned on each side of the magnetized layer of material.

12. The exercise mat of claim 9, wherein the non-magnetized layer of material is a polymer fiber laminate.

13. The exercise mat of claim 9, wherein the means for enabling a user to grip the exercise mat is at least one hand grip.

14. The exercise mat of claim 13, wherein the at least one handgrip is coupled to the magnetized layer of material by an attachment ring secured to the magnetized layer of material.

15. The exercise mat of claim 9, wherein the means for enabling a user to grip the exercise mat is at least one opening in the magnetized layer and the non-magnetized layer for the purpose of providing support to a user during various exercise activities.

16. The exercise mat of claim 9, wherein the magnetized layer has a magnetic flux in the range of 400 gauss to 500 gauss measured at an external surface of the mat.

17. An exercise mat consisting of:
a) a magnetized layer of material;
b) a non-magnetized layer of material positioned on at least one side of the magnetized layer of material; and
c) means for enabling a user to grip the exercise mat coupled to the magnetized layer of material thereby supporting a user while he or she uses the exercise mat,
wherein the magnetized layer has a magnetic flux in the range of 400 gauss to 800 gauss measured at an external surface of the mat,
whereby the exercise mat provides magnetic stimulation while a user engages the exercise mat while performing various exercise activities, including yoga.

18. The exercise mat of claim 17, wherein the non-magnetized layer of material is positioned on each side of the magnetized layer of material.

19. The exercise mat of claim 17, wherein the means for enabling a user to grip the exercise mat is at least one opening in the magnetized layer and the non-magnetized layer for the purpose of providing support to a user during various exercise activities.

20. The exercise mat of claim 17, wherein the magnetized layer has a magnetic flux in the range of 400 gauss to 500 gauss measured at an external surface of the mat.
